(19) United States
(12) Patent Application Publication
(10) Pub. No.: US 2018/0067646 A1
(43) Pub. Date: Mar. 8, 2018

(54) INPUT SYSTEM AND INPUT METHOD

(71) Applicants: Inventec Appliances (Pudong) Corporation, Shanghai (CN); Inventec Appliances Corp., New Taipei City (TW); Inventec Appliances (Shanghai) Co., Ltd., Shanghai (CN)

(72) Inventors: Jing-Song CHANG, Shanghai (CN); Yong-Ping ZHENG, Shanghai (CN); Shih-Kuang TSAI, Shanghai (CN)

(21) Appl. No.: 15/698,633

(22) Filed: Sep. 7, 2017

(30) Foreign Application Priority Data
Sep. 8, 2016 (CN) 201610808613.7

(51) Int. Cl. G06F 3/0488; G06F 3/041; G06F 3/0484

(52) U.S. Cl. CPC G06F 3/04886; G06F 3/0416; G06F 3/147; G06F 2203/04102; G06F 3/04845

(57) ABSTRACT

An input system includes a touch control device, a processing device, and a keyboard positioning device. The touch control device is configured to detect a plurality of touch points of a touch event. The processing device is configured to process the touch points for obtaining a relationship among the touch points and a position of each of the touch points. The keyboard positioning device is configured to provide a virtual keyboard according to the relationship among the touch points, and position the virtual keyboard on the touch control device according to the positions of the touch points.

### RELATED APPLICATIONS

This application claims priority to China Application Serial Number 201610808613.7, filed Sep. 8, 2016, which is herein incorporated by reference.

### BACKGROUND

### Field of Invention

The present invention relates to an input system and an input method. More particularly, the present invention relates to an input system and an input method adapted to providing a virtual keyboard according to touch positions and finger characteristics of a user.

### Description of Related Art

Text input is usually the most efficient and common method for inputting, which is performed by striking various kinds of soft (hard) keyboards to directly enter the symbols correspondingly on the keyboards, or performed by assembling the input symbols into meaningful coding assemblies according to the encoding rule. After that, the input system extracts the text corresponding to the coding assemblies for inputting.

The above text input method is widely applied. However, many limitations exist in practical applications. For example, owing to the hardware structural characteristics of the keyboard, the keyboard usually needs to be fabricated as a plate-like structure, which in turn causes limitations in the body posture and hand position when a user performs inputting. In addition, the relative positions of keys of a keyboard are fixed so the user is required to adapt himself/herself to the keys of the keyboard. When a different keyboard is used, a large amount of time is spent in getting accustomed to the keys of the keyboard, thus not only being inconvenient but also wasting the user's time.

For the forgoing reasons, there is a need to solve the above-mentioned problems by providing an input system and an input method, which is also an objective that the industry is eager to achieve.

### SUMMARY

The summary aims to provide a brief description of the disclosure so that readers can understand the disclosure fundamentally. The summary does not describe the disclosure completely, and does not intend to specify the important/critical elements of the embodiments of the present invention or limit the scope of the present invention.

An input system is provided. The input system comprises a touch control device, a processing device, and a keyboard positioning device. The touch control device is configured to detect a plurality of touch points of a touch event. The processing device is configured to process the touch points for obtaining a relationship among the touch points and a position of each of the touch points. The keyboard positioning device is configured to provide a virtual keyboard according to the relationship among the touch points, and position the virtual keyboard on the touch control device according to the positions of the touch points.

The invention provides an input method. The input method is applied to a touch control device. The input method comprises the following steps: detecting a plurality of touch points of a touch event by a touch control device; obtaining a relationship among the touch points and a position of each of the touch points; providing a virtual keyboard according to the relationship among the touch points; and positioning the virtual keyboard on the touch control device according to the positions of the touch points.

The invention further provides an input system. The input system comprises a touch control device, a processing device, and a keyboard positioning device. The touch control device is configured to detect a plurality of touch points of a touch event. The processing device is configured to process the touch points for obtaining a relationship among the touch points and a position of each of the touch points, and obtain touch characteristics of the each of the touch points according to the relationship among the touch points. The keyboard positioning device is configured to provide a plurality of modular keyboards correspondingly according to the touch characteristics of the touch points, and position the modular keyboards on the touch control device according to the positions of the touch points.

Therefore, the present invention provides the input system and the input method that can be adapted to providing the virtual keyboard according to the touch positions and finger characteristics of the user. The user is thus allowed to freely place his/her hands on the touch control device and perform inputting through the virtual keyboard, which in turn liberates the position limitation of placement of the human hands, and provides the virtual keyboard with suitable keys according to the characteristics of the user's fingers. The input system is thus able to actively perform adjusting to conform to the finger characteristics of the user.

It is to be understood that both the foregoing general description and the following detailed description are by examples, and are intended to provide further explanation of the invention as claimed.

### BRIEF DESCRIPTION OF THE DRAWINGS

FIG. 1 depicts a schematic diagram of an input system according to embodiments of this invention;

FIG. 2 depicts a schematic diagram of a positioning method of a touch control device according to embodiments of this invention;

FIG. 3 depicts a schematic diagram of a positioning method of a touch control device according to embodiments of this invention;

FIG. 4 depicts a schematic diagram of keys of a virtual keyboard according to embodiments of this invention;

FIG. 5 depicts a schematic diagram of keys of a virtual keyboard according to embodiments of this invention;

FIG. 6 depicts a schematic diagram of keys of a virtual keyboard according to embodiments of this invention;

FIG. 7 depicts a schematic diagram of keys of a modular keyboard according to embodiments of this invention;

FIG. 8 depicts a flowchart of an input method according to embodiments of this invention;

FIG. 9 depicts a flowchart of an input method according to embodiments of this invention; and

FIG. 10 depicts a flowchart of an input method according to embodiments of this invention.

### DESCRIPTION OF THE EMBODIMENTS

Unless otherwise defined herein, scientific and technical terminologies employed in the present disclosure shall have the meanings that are commonly understood and used by one of ordinary skill in the art. Unless otherwise required by context, it will be understood that singular terms shall include plural forms of the same and plural terms shall include the singular. Specifically, as used herein and in the claims, the singular forms “a” and “an” include the plural reference unless the context clearly indicates otherwise.

As used herein, “couple” refers to direct physical contact or electrical contact or indirect physical contact or electrical contact between two or more devices. Or it can also refer to reciprocal operations or actions between two or more devices.

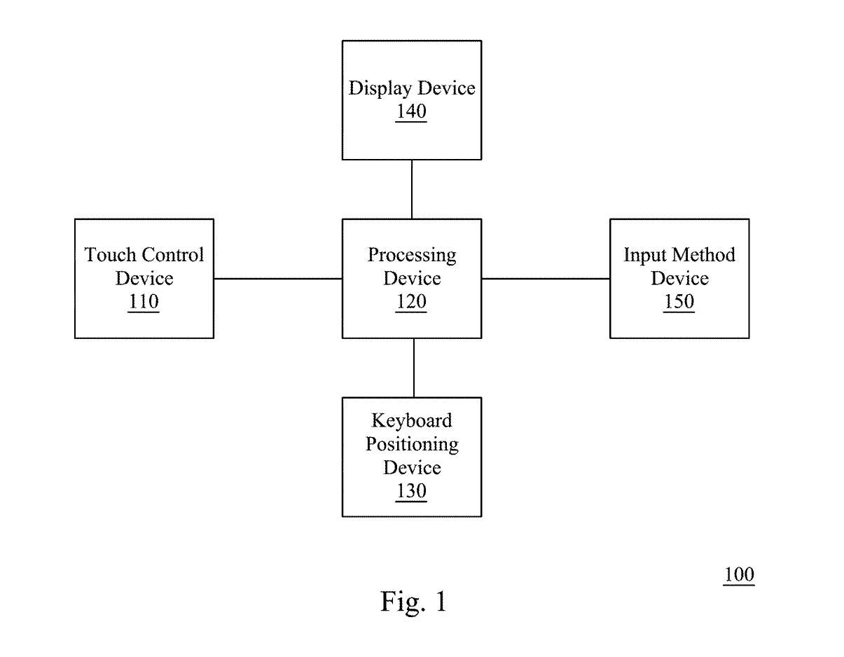

FIG. 1 depicts a schematic diagram of an input system 100 according to embodiments of this invention. As show in FIG. 1, the input system 100 comprises a touch control device 110, a processing device 120, a keyboard positioning device 130, a display device 140, and an input method device 150. As for the connection relationships, the processing device 120 is coupled to the touch control device 110, the keyboard positioning device 130, the display device 140, and the input method device 150. However, the present invention is not limited to the connection relationships shown in FIG. 1, and each of the devices may be connected to other device(s) through a wired or a wireless method depending on practical needs. For example, although in FIG. 1 the touch control device 110 is connected to the processing device 120 through a wired method, the touch control device 110 and the processing device 120 may also be connected through a wireless method in practices. For example, each of the touch control device 110 and the processing device 120 may comprise a wireless communication unit (not shown in the figure) for performing a wireless communication with each other.

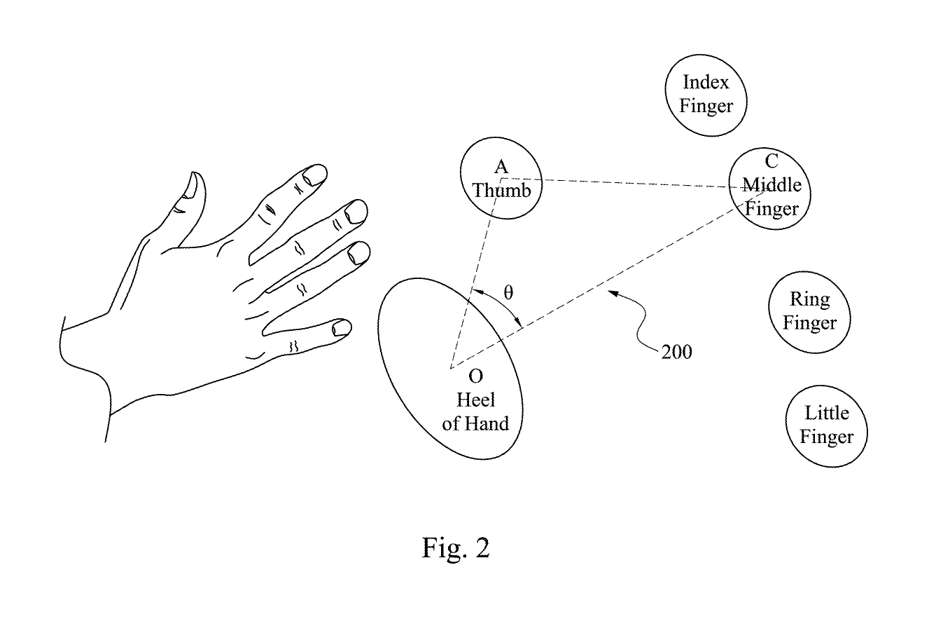

In operations, the touch control device 110 is configured to detect touch points of a touch event. In one embodiment, the touch control device 110 may be but not limited to a flexible touch control device, such as intelligent wearable device. In order to facilitate the understanding of the operational features of the touch control device 110, a description is provided with reference to FIG. 1 and FIG. 2. FIG. 2 depicts a schematic diagram of a positioning method of the touch control device 110 of the input system 100. As shown in FIG. 2, when a user puts his/her hand on the touch control device 110, the touch control device 110 can detect an occurrence of the touch event, and detect the touch points generated on the touch control device 110 by the touch event. For example, the touch control device 110 can detect five fingers and a heel of hand of the user and the touch points in contact with them.

After that, the touch control device 110 can transmit information of the touch points generated by the touch event to the processing device 120 through a wired or a wireless method. The processing device 120 processes the touch points, and then obtains a relationship among the touch points and positions of the touch points. For example, the processing device 120 can process at least three touch points to obtain a triangular position relationship. For instance, the processing device 120 can process a touch point A of a thumb, a touch point C of a middle finger, and a touch point O of the heel of hand to obtain a triangular relationship 200 shown in the figure, and obtain positions of the touch point A of the thumb, the touch point C of the middle finger, and the touch point O of the heel of hand.

Then, the processing device 120 transmits the relationship among the touch points to the keyboard positioning device 130. The keyboard positioning device 130 provides a virtual keyboard according to the relationship, and positions the virtual keyboard on the touch control device 110 according to the positions of the touch points. For example, the keyboard positioning device 130 can provide the virtual keyboard according to the triangular relationship 200. The triangular relationship 200 comprises physiological features of a user's palm. For example, one side OA of the triangular relationship 200 is a distance between the heel of hand and the thumb of the user. Another side OC is a distance between the heel of hand and the middle finger of the user. A third side AC is a distance between the thumb and the middle finger of the user. The keyboard positioning device 130 can thus provide a virtual keyboard suitable for a size of the user's palm and a relationship among fingers according to the physiological features of the palm comprised in the triangular relationship 200, and position the virtual keyboard at a location on the touch control device 110 correspondingly according to positions on the touch control device 110 touched by the user's fingers for the user to perform inputting.

In one embodiment, a standard keyboard is built into the keyboard positioning device 130. A size of this standard keyboard conforms to a size of a standard keyboard for a regular hand. However, the present invention is not limited in this regard. The standard keyboard is not limited to being stored in the keyboard positioning device 130, it can also be stored in some other component of the input system 100, such as being stored in a memory of the processing device 120. After the user's hand touches the touch control device 110 and the processing device 120 obtains the triangular relationship 200, the physiological features of the user's palm comprised in the triangular relationship 200 are simultaneously obtained, such as the distance between the heel of hand and the thumb OA, the distance between the heel of hand and the middle finger OC, etc. If it is assumed that the distance between the heel of hand and the thumb OA has a length of A and a length between a heel of hand and a thumb of the regular hand recorded in the standard keyboard is a, the processing device 120 can compare the length between the heel of hand and the thumb of the user A with the length between the heel of hand and the thumb of the standard keyboard a to obtain a ratio A/a between them. The keyboard positioning device 130 can be adapted to adjusting the standard keyboard according the above ratio A/a, so that the virtual keyboard is provided on the touch control device 110 for being adapted to the requirements of different finger lengths. Additionally, the processing device 120 may also use an angle θ between the two sides OA, OC of the triangular relationship 200 as a basis for being adapted to adjusting the standard keyboard so as to provide the virtual keyboard on the touch control device 110.

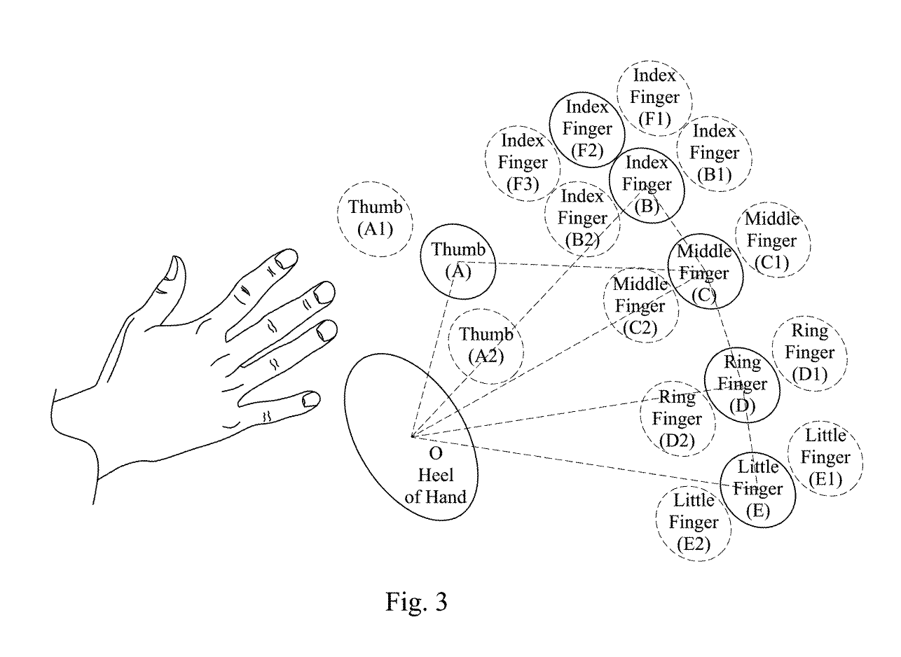

The positioning method according the present invention is not limited to the triangular relationship 200 presented by the heel of hand, the thumb, and the middle finger of the user, and the triangular positioning may be performed by selecting other parts of the user's palm depending on practical needs, as shown in FIG. 3. For example, the heel of hand, the index finger, and the middle finger may be used to perform positioning; the heel of hand, the middle finger, and the ring finger may be used to perform positioning; or the heel of hand, the ring finger, and the little finger may be used to perform positioning.

In one embodiment, dynamic keys of the virtual keyboard provided by the input system 100 are positioned on the touch control device 110 according to the posture of the user's palm and the finger features. When the input system 100 is used for the first time, the positioning may be performed through the operational method described in the above embodiment, and the triangular relationship formed by the palm of the user can be recorded in the input system 100. A description is provided with reference to FIG. 3. The input system 100 may set the dynamic keys of the virtual keyboard according to the operating characteristics of the fingers so that each of the fingers is extended to correspond to three keys. For example, the index finger corresponds to a key B, a key B1, and a key B2. In addition, based on activity characteristics of the different fingers, the keys can be further set. For example, the index finger may be further extended to correspond to a key F1, a key F2, and a key F3. The relationships between the various keys may be defined depending on practical needs.

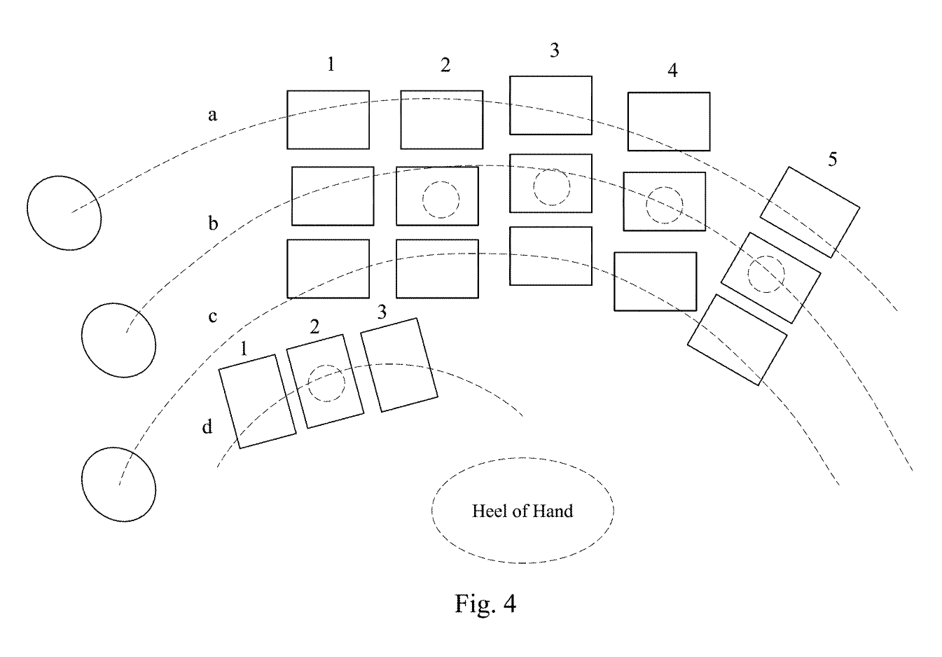

FIG. 4 depicts a schematic diagram of keys of a virtual keyboard according to embodiments of this invention. The input system 100 can provide the virtual keyboard shown in FIG. 4 on the touch control device 110 through the operational method described in the above embodiment. The virtual keyboard is based on the regular hand, and is adapted to being adjusted by using finger features of a user so as to provide an ergonomic virtual keyboard for all users.

As shown in FIG. 4, take a right hand for example. A virtual keyboard corresponding to the right hand may comprise but is not limited to eighteen keys. Dash circles in the figure represent predetermined positions where various fingers of a palm are placed. When a user uses the input system 100 for the first time, the input system 100 can be adapted to adjusting the predetermined positions where the fingers are placed according to finger features of the user. For example, spacing between rows a, b, c, d and spacing between columns 1, 2, 3, 4, 5 are simultaneously adjusted and calibrated according to the finger features of the user, and the virtual keyboard thus calibrated is recorded in the input system 100. Hence, when a same user wants to use the virtual keyboard next time, the calibrated virtual keyboard is directly pulled up to allow the user to perform inputting directly through the virtual keyboard. An example of corresponding relationships between the eighteen keys of the above virtual keyboard and the fingers of the user is shown as follows:

TABLE 1
Comparison table between the keys of the
virtual keyboard and the various fingers

| Thumb | Index Finger | Middle Finger | Ring Finger | Little Finger |
|---|---|---|---|---|
| d1~d3 | a1~a2, | a3, b3, c3 | a4, b4, c4 | a5, b5, c5 |
| | b1~b2, | | | |
| | c1~c2 | | | |

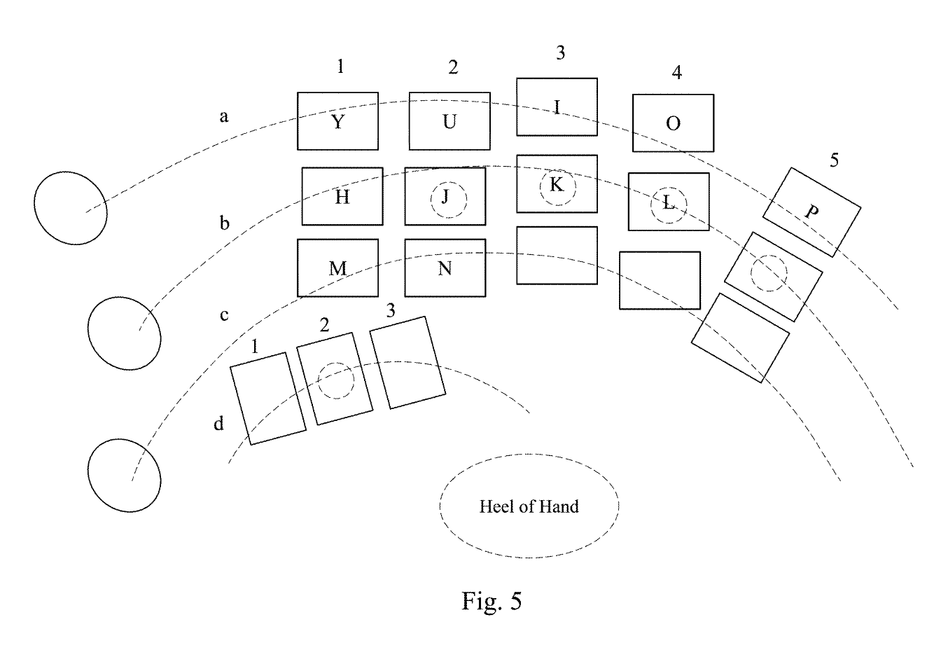

FIG. 5 depicts a schematic diagram of keys of a virtual keyboard according to embodiments of this invention. When a user performs inputting for the first time, the user needs to select an input method. A description is provided with reference to FIG. 1 and FIG. 5. After the input system 100 provides the virtual keyboard, the user can select the input method through the virtual keyboard on the touch control device 110. The processing device 120 will generate an input selection instruction according to the selection of the input method, and transmit the input selection instruction to the input method device 150. After that, the input method device 150 provides the input method corresponding to the virtual keyboard according the input selection instruction. For example, the user selects computer input of English characters through the virtual keyboard on the touch control device 110. The processing device 120 generates the input selection instruction accordingly and transmits the input selection instruction to the input method device 150. The input method device 150 provides the full keyboard input method with 26 English letters according to the input selection instruction.

In one embodiment, when performing the selection for the input method, the display device 140 may be used to display the input method selected by the virtual keyboard of the touch control device 110. Additionally, the display device 140 may also be configured to display information input by the virtual keyboard. For example, after the full keyboard input method with 26 English letters is selected, the display device 140 may be configured to display letters input through the computer input of English characters by the user. Additionally, the display device 140 may be but is not limited to a mobile phone screen, a computer screen, a TV screen, a projection screen, etc. After the information input by the virtual keyboard of the touch control device 110 is processed by the processing device 120, the information is displayed on the display device 140. The display device 140 and the processing device 120 may be connected through a wired or a wireless method, such as being connected through various signal wires, Wifi, Bluetooth, or mobile communication protocol(s).

FIG. 5 depicts a virtual keyboard corresponding to a right hand. Based on the above input method, the right hand takes responsibility of English letters h, j, k, l, m, n, y, u, i, o, and p. In addition, a left hand takes responsibility of English letters a, s, d, f, g, q, w, e, r, t, z, x, c, v, and b. Additionally, instructions such as selection, confirmation, page turning, etc. may be realized through key combinations or through thumb keys d1-d3. Each of the keys and the input letter or instruction corresponding to the each of the keys may be further designed depending on practical needs, or various key combinations may even be customized to input special instructions, or the keys may be adjusted according to user habits, or a user may increase or decrease function of the key(s) based on his/her personal needs. For example, part of the keys in FIG. 5 may be set not to have the function for inputting any symbol.

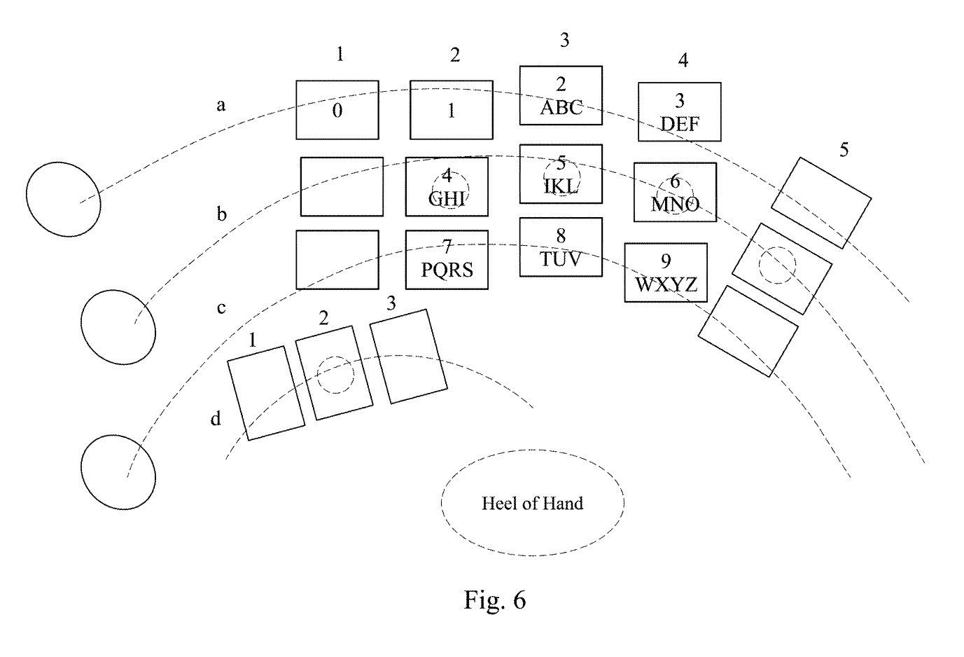

FIG. 6 depicts a schematic diagram of keys of a virtual keyboard according to embodiments of this invention. Not only can the input method device 150 provide the full keyboard input method with 26 English letters shown in FIG. 5, but the input method device 150 can also provide a one handed keyboard for inputting English characters shown in FIG. 6 according to user's habits. Each of the keys and the input letter, number, or instruction corresponding to the each of the keys may be further designed depending on practical needs. Take the number input for example. Number keys in an ath row and in a cth row may be adjusted to fulfill the needs of different users. Or, left handed keys and right handed keys may be swapped according to user's habits, such as left handedness or right handedness. The input method device 150 according to the present invention may provide a variety of conventional input methods, such as the phonetic input method, the Tsang-Jye input method, the Boshiamy method, the Dayi method, etc., or may merely provide a number keyboard, a telephone keyboard, etc. depending on practical needs.

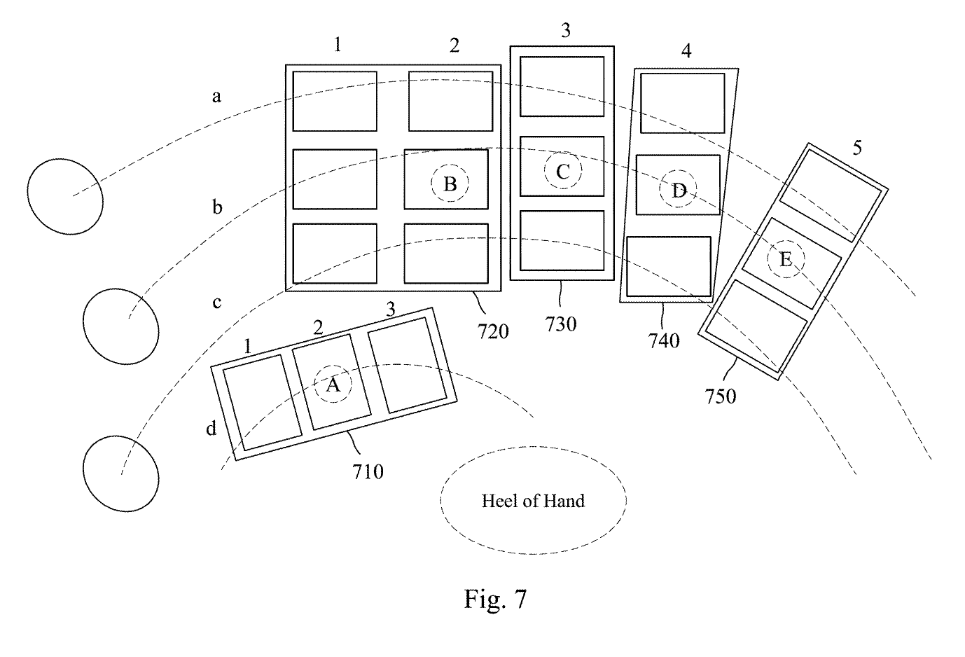

FIG. 7 depicts a schematic diagram of keys of a modular keyboard according to embodiments of this invention. As compared with the input system 100 according to the above embodiments in which a complete virtual keyboard is provided according to the relationship among the touch points, the embodiment in FIG. 7 provides a modular keyboard correspondingly according to touch characteristics of each of the touch points. A description is provided as follows.

A description is provided with reference to FIG. 1 and FIG. 7. When a user puts his/her hand on the touch control device 110, the touch control device 110 can detect the touch points of the touch event. After the processing device 120 processes the touch points, a relationship among the touch points and positions of the touch points are obtained and touch characteristics of each of the touch points are obtained according to the relationship among the touch points. For example, dash circles in FIG. 7 represent positions where various fingers of a palm touch the touch control device 110. After the processing device 120 processes the touch points, a relationship among five fingers can be obtained. Based on a feature of a human palm, such as the fingers of the right hand being arranged in a sequence thumb, index finger, middle finger, ring finger, and little finger, the processing device 120 can obtain the touch characteristics of each of the touch points according to the above feature. For example, it is known that a touch point A corresponds to the thumb, a touch point B corresponds to the index finger, and so forth after analyzing, which is called the touch characteristics of each of the touch points A-B and touch points C-E.

Then, the keyboard positioning device 130 provides a plurality of modular keyboards correspondingly according to the touch characteristics of the touch points, and positions the modular keyboards on the touch control device 110 according to the positions of the touch points. For example, the keyboard positioning device 130 provides a thumb keyboard 710 according to the touch characteristics that the touch point A corresponds to the thumb, the keyboard positioning device 130 provides an index finger keyboard 720 according to the touch characteristics that the touch point B corresponds to the index finger, and so forth. After that, the keyboard positioning device 130 positions the thumb keyboard 710 on the touch control device 110 according to a position of the touch point A, positions the index finger keyboard 720 on the touch control device 110 according to a position of the touch point B, and so forth. The thumb keyboard 710, the index finger keyboard 720, a middle finger keyboard 730, a ring finger keyboard 740, and a little finger keyboard 750 are modular keyboards designed according to features of human fingers so as to meet ergonomic requirements. For example, based on activity characteristics of the different fingers, the index finger keyboard 720 for the index finger is designed as six keys arranged in two columns because the index finger generally moves more flexibly and can operate within a larger range. The activity characteristics of the other fingers are lower. Hence, the keyboards for the other fingers are designed as three keys arranged in one column.

In addition, based on differences between moving directions of the different fingers, each of the finger keyboards may be designed as a lateral keyboard or a longitudinal keyboard. For example, the moving direction of the thumb is lateral so the keyboard for the thumb is designed as a lateral keyboard. The moving directions of the other fingers are longitudinal so the keyboards for the other fingers are designed as longitudinal keyboards. In greater detail, based on ergonomics, the moving direction of the thumb is lateral but at an inclination angle to a horizontal line, the keyboard for the thumb is thus designed as a lateral but slightly inclined keyboard. The moving directions of the index finger and the middle finger are approximately longitudinal, the keyboards for the index finger and the middle finger are thus designed as longitudinal keyboards accordingly. Each of the moving directions of the ring finger and the little finger is longitudinal but at an inclination angle to a vertical line, the keyboards for the middle finger and the little finger are thus designed as longitudinal but slightly inclined keyboards. The keys and directions of the modular keyboards may be designed depending on practical needs to further meet ergonomic requirements.

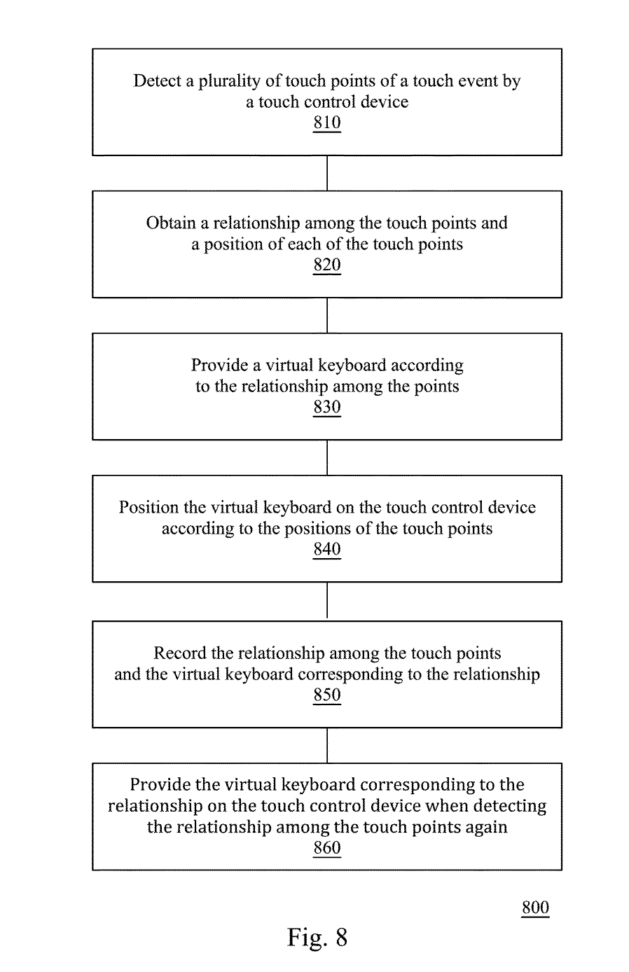

In order to facilitate the understanding of the input method 800 according to the embodiment of the present invention, a description is provided with reference to FIG. 1 and FIG. 8. In step 810, the touch control device 110 detects the touch points of the touch event. In step 820, the processing device 120 obtains the relationship among the touch points and the position of the each of the touch points after processing the touch points. In step 830, the keyboard positioning device 130 provides the virtual keyboard according to the relationship among the points. In step 840, the keyboard positioning device 130 positions the virtual keyboard on the touch control device 110 according to the positions of the touch points to allow a user to perform inputting through the virtual keyboard. In one embodiment, the touch control device 110 comprises a flexible touch device, such as intelligent wearable device.

Similarly, a description is provided with reference to FIG. 1 and FIG. 8 to facilitate the understanding of the input method 800 according to the embodiment of the present invention. In step 850, the input system 100 records the relationship among the touch points and the virtual keyboard corresponding to the relationship. In step 860, the input system 100 provides the virtual keyboard corresponding to the relationship on the touch control device 110 when detecting the relationship among the touch points again.

A description is provided with reference to FIG. 1, FIG. 2, and FIG. 8. In one embodiment, step 810 comprises the following process: the touch control device 110 detects the at least three touch points A, C, O of the touch event. Step 820 comprises the following process: the processing device 120 obtains the triangular relationship 200 formed by the at least three touch points A, C, O. Step 830 comprises the following process: the keyboard positioning device 130 provides the virtual keyboard according to the triangular relationship 200. In another embodiment, the step of providing the virtual keyboard according to the triangular relationship 200 further comprises the following process: adjusting a standard keyboard to provide the virtual keyboard according to the lengths of the sides OA, OC, AC and the angle θ between the two sides OA, OC.

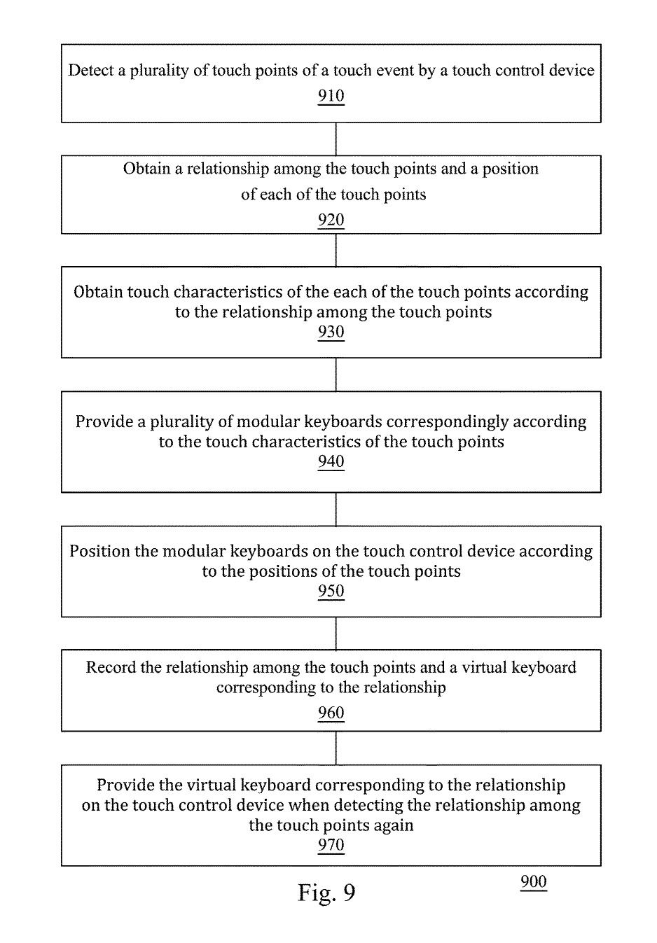

In order to facilitate the understanding of the input method 900 according to the embodiment of the present invention, a description is provided with reference to FIG. 1 and FIG. 9. In step 910, the touch control device 110 detects the touch points of the touch event. In step 920, the processing device 120 obtains the relationship among the touch points and the position of the each of the touch points after processing the touch points. In step 930, the processing device 120 obtains the touch characteristics of the each of the touch points according to the relationship among the touch points. In step 940, the keyboard positioning device 130 provides the modular keyboards correspondingly according to the touch characteristics of the touch points. In step 950, the keyboard positioning device 130 positions the modular keyboards on the touch control device 110 according to the positions of the touch points. In one embodiment, the touch control device 110 comprises a flexible touch device, such as intelligent wearable device.

Similarly, a description is provided with reference to FIG. 1 and FIG. 9 to facilitate the understanding of the input method 900 according to the embodiment of the present invention. In step 960, the input system 100 records the relationship among the touch points and a virtual keyboard corresponding to the relationship. In step 970, the input system 100 provides the virtual keyboard corresponding to the relationship on the touch control device 110 when detecting the relationship among the touch points again.

A description is provided with reference to FIG. 1, FIG. 7, and FIG. 9. In one embodiment, step 930 comprises the following process: the processing device 120 obtains the touch characteristics of the touch points A-E according to relative positions of the touch points A-E (for example, the touch point A corresponds to the thumb, the touch point B corresponds to the index finger, and so forth). Step 940 comprises the following process: the keyboard positioning device 130 provides different modular keyboards (for example, the touch point A corresponds to the thumb so the thumb keyboard 710 is provided) correspondingly according to different touch characteristics.

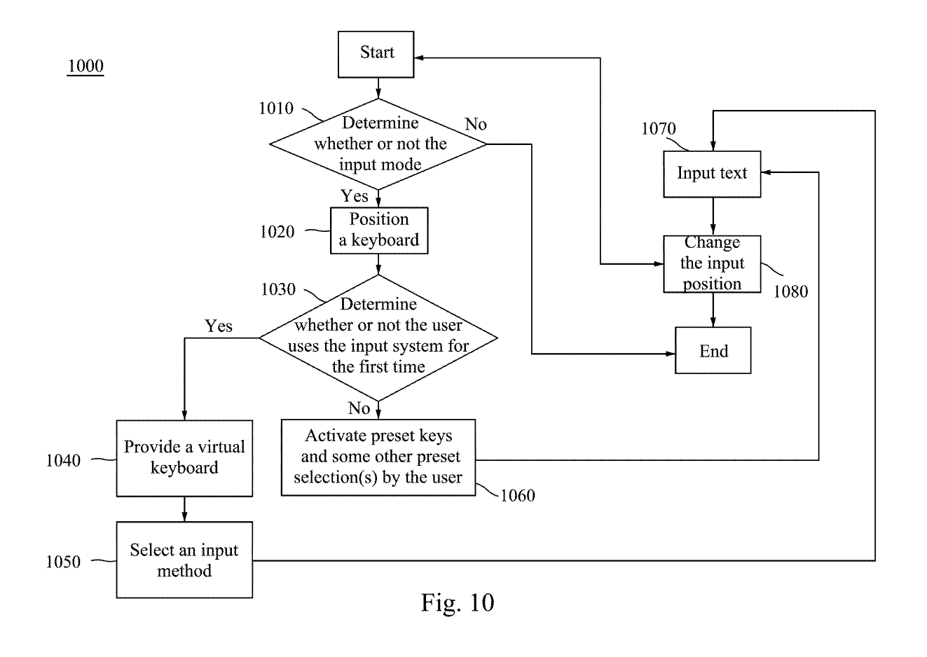

FIG. 10 depicts a flowchart of an input method 1000 according to embodiments of this invention. As shown in FIG. 10, when a user wants to perform inputting, the user puts his/her hand on a suitable part of the body and uses a palm and five fingers to touch a surface of a piece of intelligent equipment. An allowable input position for the intelligent wearable device may be but not limited to an arm, a wrist, a thigh, a calf, etc. Any position that facilitates the touch operations of the user would be appropriate. When the user stands up, the allowable input position for the intelligent wearable device may be the arm or the wrist. When the user sits down, the allowable input position for the intelligent wearable device may be the thigh. When the user crosses his/her legs, the allowable input position for the intelligent wearable device may be the calf. The input position for the intelligent wearable device may be designed depending on practical operating scenarios. After the user's palm and five fingers touch the intelligent wearable device, a verification procedure can be turned on through a default mode, such as requiring the user to enter a password so as to activate an input mode through the intelligent wearable device. The above mechanism is used to prevent the user from inadvertently touching the intelligent wearable device when the user does not want to perform inputting. The method for entering the password may adopt various common methods. The input system 100 shown in FIG. 1 will verify the above password to determine whether or not the user wants to activate the input mode (step 1010). Once the input system 100 determines that the user wants to activate the input mode, the input system 100 positions a keyboard according to user's touch points (step 1020).

Then, it is determined whether or not the user uses the input system 100 for the first time (step 1030). The input system 100 searches whether or not a usable triangular position relationship is available. If not, the user has not used the input system 100 before so there is no triangular position relationship of features of the user's palm. At this time, the features of the user's palm are detected through the input system 100 and a virtual keyboard is provided correspondingly (step 1040). After that, the user can select an input method (step 1050). After performing step 1040 and step 1050, the input system 100 can store information of the user to allow the user to directly pull up the corresponding virtual keyboard that matches the preset input method when the user uses the input system 100 again. It is thus very convenient for the user.

If the input system 100 retrieves the usable triangular position relationship, then the user has used the input system 100 before. At this time, it is only necessary to provide the virtual keyboard according to preset keys and some other preset selection(s) by the user (step 1060), and turn on an input function to allow the user to input text (step 1070). In addition, during the process of inputting text, if the user puts his/her palm at some other position due to a change in posture or some other factor, the input system 100 can immediately detect and change the input position correspondingly (step 1080).

It is therefore understood from the embodiments of the present invention that the present invention has the following advantages. The present invention provides the input system and the input method that can be adapted to providing the virtual keyboard according to the touch positions and finger characteristics of the user. The user is thus allowed to freely place his/her hands on the touch control device and perform inputting through the virtual keyboard, which in turn liberates the position limitation of placement of the human hands, and provides the virtual keyboard with suitable keys according to the characteristics of the user's fingers. The input system is thus able to actively perform adjusting to conform to the finger characteristics of the user.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An input system comprising:
a touch control device configured to detect a plurality of touch points of a touch event;
a processing device configured to process the touch points for obtaining a relationship among the touch points and a position of each of the touch points; and
a keyboard positioning device configured to provide a virtual keyboard according to the relationship among the touch points, and position the virtual keyboard on the touch control device according to the positions of the touch points.

2. The input system of claim 1, wherein the touch control device is configured to detect at least three touch points of the touch event, the processing device is configured to process the touch points to obtain a triangular position relationship of the at least three touch points, the keyboard positioning device is configured to provide the virtual keyboard according to the triangular position relationship.

3. The input system of claim 2, wherein the triangular position relationship comprises lengths of sides of a triangle and an angle between any two of the sides of the triangle, wherein the keyboard positioning device comprises a standard keyboard, the keyboard positioning device adjusts the standard keyboard to provide the virtual keyboard according to the lengths of the sides and the angle.

4. The input system of claim 1, wherein the touch control device comprises a first wireless communication unit, the processing device comprises a second wireless communication unit, wherein the touch control device communicates with the second wireless communication unit of the processing device through the first wireless communication unit.

5. The input system of claim 1, wherein the touch control device comprises a flexible touch device.

6. The input system of claim 1, further comprising:
a display unit configured to display information input by the virtual keyboard of the touch control device.

7. The input system of claim 1, further comprising:
an input method device configured to provide an input method corresponding to the virtual keyboard according to an input selection instruction of the virtual keyboard of the touch control device.

8. An input method applied to a touch control device comprising:
detecting a plurality of touch points of a touch event by the touch control device;
obtaining a relationship among the touch points and a position of each of the touch points;
providing a virtual keyboard according to the relationship among the touch points; and
positioning the virtual keyboard on the touch control device according to the positions of the touch points.

9. The input method of claim 8, wherein detecting the touch points of the touch event by the touch control device comprises:
detecting at least three touch points of the touch event by the touch control device;
wherein obtaining the relationship among the touch points comprises:
obtaining a triangular position relationship of the at least three touch points;
wherein providing the virtual keyboard according to the relationship among the touch points comprises:
providing the virtual keyboard according to the triangular position relationship.

10. The input method of claim 9, wherein the triangular position relationship comprise lengths of sides of a triangle and an angle between any two of the sides of the triangle, wherein providing the virtual keyboard according to the triangular position relationship comprises:
adjusting a standard keyboard to provide the virtual keyboard according to the lengths of the sides and the angle.

11. The input method of claim 8, further comprising:
recording the relationship among the touch points and the virtual keyboard corresponding to the relationship; and
providing the virtual keyboard corresponding to the relationship on the touch control device when detecting the relationship among the touch points again.

12. The input method of claim 8, further comprising:
obtaining touch characteristics of the each of the touch points according to the relationship among the touch points;
providing a plurality of modular keyboards correspondingly according to the touch characteristics of the touch points; and
positioning the modular keyboards on the touch control device according to the positions of the touch points.

13. The input method of claim 12, wherein the relationship among the touch points comprises relative positions of the touch points, wherein obtaining the touch characteristics of the touch points according to the relationship among the touch points comprises:
obtaining the touch characteristics of the touch points according to the relative positions of the touch points;
wherein providing the modular keyboards correspondingly according to the touch characteristics of the touch points comprises:
providing different modular keyboards correspondingly according to different touch characteristics.

14. The input method of claim 12, further comprising:
recording the relationship among the touch points and the modular keyboards corresponding to the relationship; and
providing the modular keyboards corresponding to the relationship on the touch control device when detecting the relationship among the touch points again.

15. An input system comprising:
a touch control device configured to detect a plurality of touch points of a touch event;
a processing device configured to process the touch points for obtaining a relationship among the touch points and a position of each of the touch points, and obtain touch characteristics of the each of the touch points according to the relationship among the touch points; and
a keyboard positioning device configured to provide a plurality of modular keyboards correspondingly according to the touch characteristics of the touch points, and position the modular keyboards on the touch control device according to the positions of the touch points.

16. The input system of claim 15, wherein the relationship among the touch points comprises relative positions of the touch points, the processing device is configured to obtain the touch characteristics of the touch points according to the relative positions of the touch points, wherein the keyboard positioning device is configured to provide different modular keyboards correspondingly according to different touch characteristics.

17. The input system of claim 15, wherein the touch control device comprises a first wireless communication unit, the processing device comprises a second wireless communication unit, wherein the touch control device communicates with the second wireless communication unit of the processing device through the first wireless communication unit.

18. The input system of claim 15, wherein the touch control device comprises a flexible touch device.

19. The input system of claim 15, further comprising:
a display unit configured to display information input by the modular keyboards of the touch control device.

20. The input system of claim 15, further comprising:
an input method device configured to provide an input method corresponding to the modular keyboards according to an input selection instruction of the modular keyboards of the touch control device.
